(19) United States
(12) Patent Application Publication
(10) Pub. No.: US 2021/0401645 A1
(43) Pub. Date: Dec. 30, 2021

(54) MECHANISM FOR MOVING WHEELCHAIR WHEELS REARWARD

(71) Applicant: PEOPLIAN CO. LTD, Pohang-si Gyeongsangbuk-do (KR)

(72) Inventor: Yang Gyu Jei, Pohang-si (KR)

(21) Appl. No.: 17/293,024

(22) PCT Filed: Dec. 31, 2019
(86) PCT No.: PCT/KR2019/018765

§ 371 Date: May 11, 2021

(30) Foreign Application Priority Data
Jan. 4, 2019 (KR) 10-2019-0000966
Dec. 23, 2019 (KR) 10-2019-0172594

(51) Int. Cl. A61G 5/14

(52) U.S. Cl. CPC A61G 5/14

(57) ABSTRACT

One of the biggest challenges that a disabled wheelchair user faces when using a wheelchair is getting in and out of the wheelchair. The method most commonly used for getting in or out of a wheelchair is a method using a sliding board. In this method, a user lays the sliding board across a wheelchair seat and a bed and moves across by pushing his or her buttocks. However, the biggest challenge of this method is that the large size of the wheelchair wheels makes it difficult to mount the sliding board on a side surface of the wheelchair, and there is also a high risk of falling while moving. The present invention enables a wheelchair user to easily move large wheelchair wheels rearward without outside assistance by using an armrest of the wheelchair as a lever. Through the present invention, which is lightweight and enables wheelchair users to easily move a wheel rearward by themselves, disabled wheelchair users can easily get in and out of wheelchairs by themselves without outside assistance.

### BACKGROUND OF THE DISCLOSURE

### Technical Field

The present disclosure relates to a device which enables a wheelchair user to easily move large rear-wheels of a wheelchair, which are obstructions when getting in or off, rearward of the wheelchair when the wheelchair user wants to get in and off of a chair or bed in a self-propelled wheelchair with large wheels that can be driven by the user using both arms.

### Background Art

One of the biggest challenges that a disabled wheelchair user faces when using a wheelchair is getting in and out of the wheelchair. In order to put the wheelchair user on or off of the wheelchair, a nurse or guardian may lift a user with hands and move the user, or may put a transfer band on the wheelchair user and put the wheelchair user on or off of the wheelchair through the transfer band. Both methods are very difficult to use because the wheelchair user is transferred by human power, and thus, it gives a very heavy burden on the nurse or guardian. In addition, a separate device such as a hoist or a lifter may be used to pick up or drop off the user, but this method also has inconvenience of using a separate external device.

The method most often used by the wheelchair user to get in or off a self-propelled wheel body having large wheels that can be driven by the user using both arms is a method of using a sliding board. In this method, the user lays the sliding board across a wheelchair seat and a bed and moves across by sliding his or her buttocks (U.S. Pat. Nos. 4,288,124, 4,987,621, 5,067,188, 5,152,016, 5,193,233, 5,735,002, 5,947,501, and 6,748,612). However, the biggest challenge of this method is that the large size of the wheelchair rear-wheels makes it difficult to mount the sliding board on a side surface of the wheelchair. In U.S. Pat. No. 6,748,612, instead of moving the wheelchair wheels to the rear, a technology of installing a separate cradle above the wheelchair wheels and then using the cradle as a sliding board is proposed.

For a nursing care-type wheelchair having small rear-wheels of the wheelchair, it is difficult to drive the wheelchair for mobility by the wheelchair user alone, and a guardian or nurse should push the wheelchair from behind. In order to get in or off of the nursing care-type wheelchair, there is a method of laying a wheelchair side protector or the sliding board between the bed or chair to which the user is to be moved, sliding a body of the user while riding the side protector or sliding board, and putting the user in or off of the wheelchair (KR 20-2004-0035040, U.S. Pat. No. 5,060,960). The method using side protectors is difficult to apply to a self-propelled wheelchair having large wheelchair wheels, and can only be applied to the nursing-type wheelchair having small wheelchair wheels.

When the sliding board is used in the self-propelled wheelchair having large rear wheels, the sliding board cannot be installed next to a wheelchair seat due to the large rear wheels. Accordingly, as described in U.S. Pat. No. 5,947,501, a wheelchair is installed at an angle to a side of a bed, and the sliding board is installed from a front of the wheelchair seat to the bed. In this case, the installation of the sliding board is unsafe and there is a great risk of falling. As described in U.S. Pat. Nos. 3,901,527 and 4,155,588, one of the best methods is to completely move the wheelchair wheels to the rear and then install a sliding board on the side of the wheelchair.

U.S. Pat. Nos. 3,901,527 and 4,155,588 suggest an idea to move the large wheels of the wheelchair to the rear, but there is a disadvantage that it is difficult for a seated wheelchair user to directly move the rear-wheels of the wheelchair to the rear. In JP 2001-061897, U.S. Pat. No. 6,802,518, and JP 201400147661A0, a separate sliding device is installed to move a wheelchair wheel to the rear. In DE202018102424U1, a straight line movement mechanism is constituted to use a pivotable lever frame to move wheelchair wheels to the rear.

The present disclosure proposes a mechanism that allows the wheelchair user to easily move the wheelchair wheels to the rear by using wheelchair armrests alone without the help of a nurse or guardian.

### SUMMARY

### Technical Problem

In a self-propelled wheelchair having large wheelchair wheels, a wheelchair user should be able to easily move the large wheels to the rear without a help of a guardian. In addition, since the wheelchair is a passive wheelchair, it is difficult to use when a device that moves the wheelchair wheels to the rear is large or heavy. There is a need to develop a lightweight device that allows a wheelchair user to easily move the wheelchair wheels to the rear by himself/herself.

### Technical Solution

In order for a wheelchair user to get in or off of a wheelchair, a wheelchair armrest serving as a side protector should be removed or rotated to the rear side of a wheelchair back support. In the present disclosure, the armrest to be removed or rotated is used as a lever to move the wheelchair wheels to the rear.

In addition, when the wheelchair wheel is moved to the rear, a central axis of the wheelchair wheel should move in a straight line. In order to easily move the wheelchair wheels to the rear by using the wheelchair armrest as a lever, it is necessary to develop a mechanism that allows the central axis of the wheelchair wheel to move in a straight line while the wheelchair wheels roll.

In addition, in a case where a movement of the armrest and movements of the wheelchair wheels are interlocked, an armrest fixing device needs to prevent the armrest from moving easily when the wheelchair travels.

Since a disabled wheelchair user uses the wheelchair, when the wheelchair wheels are moved to the rear or when the wheelchair user gets in or off of the wheelchair, a safety issue of preventing the wheelchair from overturning is also very important.

### Advantageous Effects

When wheelchair wheels can be easily moved to the rear, a wheelchair user can easily get in or off of the wheelchair without outside assistance from a nurse or guardian. Because of this effectiveness, there have been many attempts over a long period of time to develop a mechanism that can move wheelchair wheels to the rear. When a wheelchair armrest is used as a lever and there is a lightweight mechanism that allows the wheelchair user to easily move the wheel to the rear, it will be very helpful for disabled wheelchair users to get in or off of the wheelchair.

### BRIEF DESCRIPTION OF THE DRAWINGS

FIG. 1 illustrates an overall appearance of a mechanism that easily moves wheelchair wheels to the rear using a wheelchair armrest.

FIG. 2 illustrates a mechanism for moving wheelchair wheel rearward in detail from both sides.

FIG. 3 illustrates steps in which the wheelchair wheels move to the rear when the wheelchair armrest is rotated.

FIG. 4 illustrates an appearance of a wheelchair user spreading a side protector on a patient bed to get in or off of the wheelchair after moving the wheelchair wheels to the rear, FIG. 4A illustrates a case where a height of a chair is lower than a height of the wheelchair, and FIG. 4B illustrates a case where the height of the wheelchair and the height of the chair are similar to each other.

FIG. 5 illustrates an appearance of a device for fixing the wheelchair armrest that rotates about a pivot.

FIG. 6 illustrates a separation between the wheelchair wheels and a wheelchair wheel shaft support to easily attach or detach the wheelchair wheels with respect to a wheelchair frame.

FIG. 7 illustrates how a length of a variable link is changed when the variable link rotates about a pivot, FIG. 7A illustrates an example of using the wheelchair frame as a guide rail, and FIG. 7B illustrates a state where the wheelchair frame and the guide rail are separated from each other.

### DESCRIPTION OF EXEMPLARY EMBODIMENTS

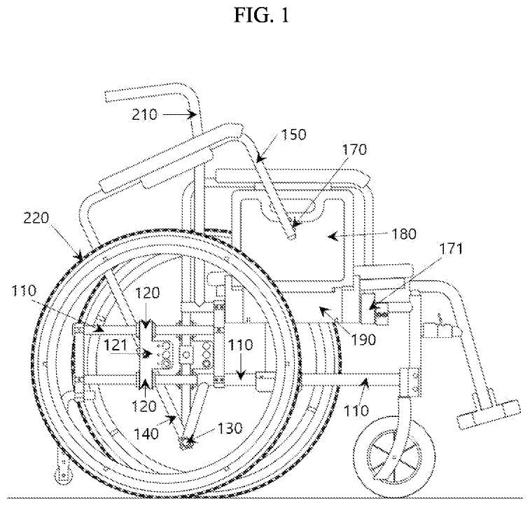

FIG. 1 illustrates an overall appearance of a mechanism for moving large wheels of a self-propelled wheelchair to the rear.

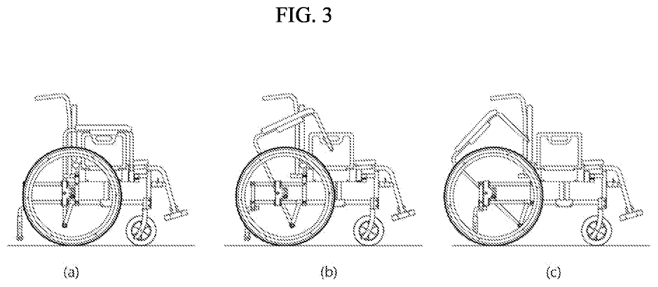

As illustrated in FIG. 1, a wheelchair frame 110 of the present disclosure has a different appearance from that of a general wheelchair frame. When a wheelchair user gets in or off of the wheelchair, the user tries to move large wheels of the wheelchair to the rear so that the large wheels of the wheelchair are not obstructions. In order to move a central axis of the wheelchair wheel supporting a load of the wheelchair user to the rear, the frame supporting the wheelchair wheel should be connected to the rear portion. Alternatively, a guide rail 111 for supporting wheelchair wheel may be added to the wheelchair frame. The wheelchair frame 110 of FIG. 1 is extended to the rear portion, unlike a general wheelchair, to move the wheelchair wheel to the rear while supporting a load of the wheelchair. As illustrated in FIG. 3A, the extended wheelchair frame does not come out of the wheelchair wheels 220, and thus, it is not inconvenient in terms of aesthetics and practical use.

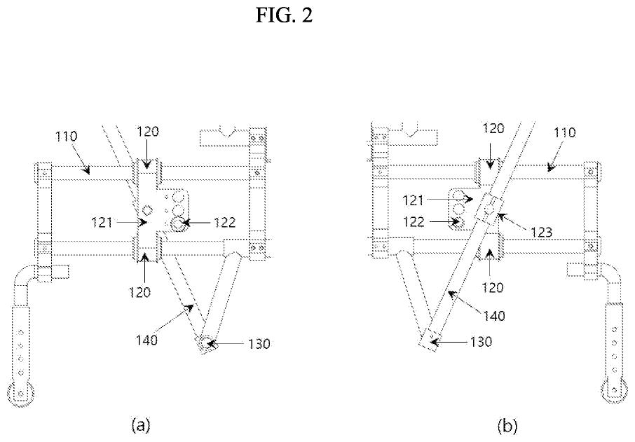

The wheelchair includes a wheelchair armrest 150, in order to get on or off the wheelchair, and the user removes the wheelchair armrest 150 or rotates the wheelchair armrest 150 to the rear side of a wheelchair back support 210 in order to get in or off of the wheelchair. In general, in many wheelchairs, a method of rotating the wheelchair armrest more than 90° to the rear side of the wheelchair back support is used. Unlike the general wheelchair armrests, the armrest 150 of the present disclosure is not fixed to the wheelchair frame, but is connected to a pivot link 140 for moving the wheelchair wheels 220 to the rear as illustrated in FIGS. 1 and 2.

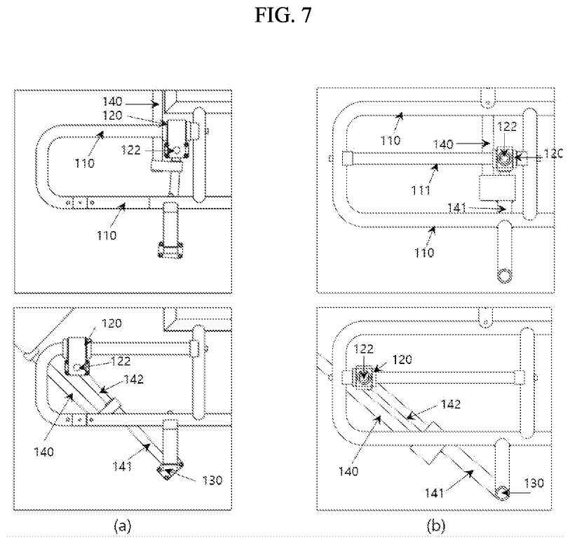

As illustrated in FIG. 2, a straight guide module 121 equipped with a wheelchair wheel shaft support 122 may easily move in a straight direction along the wheelchair frame 110 or guide rail 111 through a straight guide slider 120. As illustrated in FIG. 2, the straight guide module 121 is connected to the pivot link 140, and the pivot link 140 rotates about a pivot 130 attached to the wheelchair frame. When the pivot link 140 rotates about the pivot 130, a pivot guide slider 123 installed on the pivot link 140 has a sliding structure or variable structures 141 and 142 in which a length of the pivot link is changed as illustrated in FIG. 7. Through this, it is possible to generate a straight line movement of the straight guide slider 120 or the straight guide module 121.

The pivot 130 is fixed to the wheelchair frame 110, and thus, becomes a center of rotation of the pivot link 140. An end of the wheelchair armrest 150 is connected to the pivot link 140. When the wheelchair armrest 150 connected to the pivot link 140 rotates about the pivot 130, the straight guide module 121 connected to the pivot link 140 moves in a straight direction. For the straight line movement of the straight guide module 121, when the pivot link 140 connected to the straight guide module 121 rotates about the pivot, the pivot guide slider 123 installed on the pivot link 140 slides, or the wheelchair wheels are moved forward or rearward through the variable structures 141 and 142 by which the length of the pivot link 140 is changed.

The wheelchair wheels move forward and backward while rolling, and thus, the user can move the wheelchair wheels with less force. FIG. 3 illustrates a step-by-step process in which the wheelchair wheels 220 are moved to the rear while the wheelchair armrest 150 rotates about the pivot 130. When the straight guide module 121 having the wheelchair wheel shaft support 122 and the straight guide slider 120 moves in a straight line along the wheelchair frame 110 or the guide rail 111, sliding occurs through the pivot guide slider 123 installed on the pivot link 140 or the lengths of the variable structures 141 and 142 of the pivot link are changed.

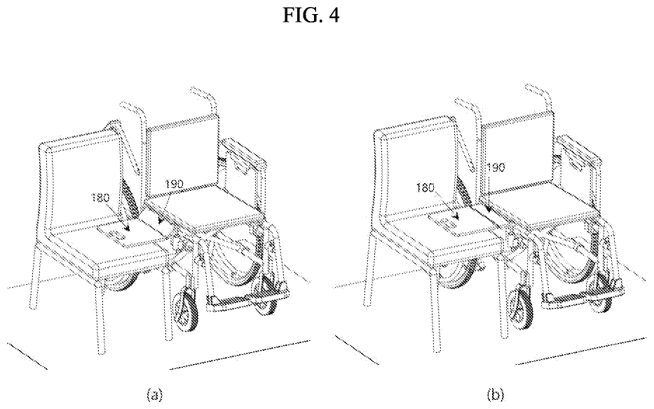

When the wheelchair wheels are moved completely to the rear, the wheelchair armrest and wheels are located as illustrated in FIG. 3C. After the wheelchair wheel is moved to the rear, as illustrated in FIG. 4, a side protector 180 attached to the wheelchair frame is pulled out and laid on a chair or a patient bed. In general, a height of a wheelchair seat and a height of the chair or patient bed of which the user is to get in or off do not match each other. Accordingly, the side protector can be easily laid on the chair or patient bed with different heights through a side protector connecter 190 capable of adjusting a height.

When the wheelchair user gets in or off of the chair or the patient bed from the wheelchair, as illustrated in FIG. 4, the user lays the side protector 180 on the chair or patient bed, and then naturally presses the side protector 180 to get on or off of the chair of patient bed. The user presses the side protector 180 laid on the chair or patient bed with hands, and thus, when the user gets on or off of the wheelchair, the wheelchair is safely fixed to the patient bed so that the wheelchair does not overturn.

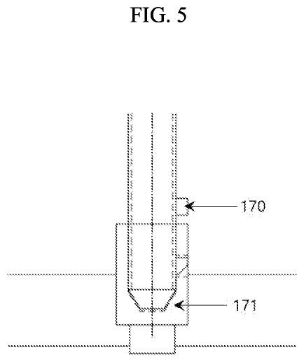

As illustrated in FIG. 3A, when the wheelchair wheels return to their original state (normal traveling state), it should be possible to fix the wheelchair wheels so that they do not move forward or rearward while traveling. FIG. 5 illustrates wheelchair armrest fixing devices 170 and 171 that fix the wheelchair armrest 150 to the wheelchair frame. When the wheelchair armrest 150 is fixed to the wheelchair frame through the wheelchair armrest fixing device 170, the central axis of the wheelchair wheel cannot move forward or rearward when the wheelchair travels.

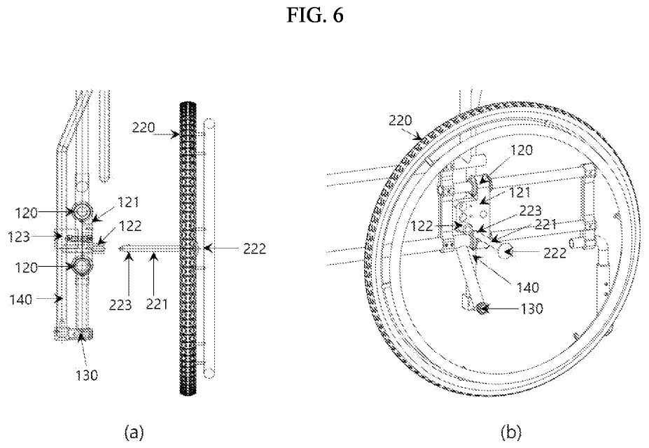

FIG. 6 illustrates an appearance of easily separating or attaching the large wheel of the wheelchair from the wheelchair frame. When the wheelchair wheel central axis pushing pin 222 is pressed, the wheelchair wheel central axis fixing ball 223 is lowered so that the wheelchair wheel can be easily fixed or separated with respect to the wheelchair wheel shaft support 122. When the wheelchair wheel central axis pushing pin 222 is not pushed, the wheelchair wheel central axis fixing ball 223 comes out so that the wheelchair wheels are fixed without being separated from the wheelchair wheel shaft support 122.

FIG. 7A illustrates the wheelchair frame 110 performing the role of the guide rail at the same time, and FIG. 7B illustrates the wheelchair frame 110 and the guide rail 111 being separated from each other.

### INDUSTRIAL AVAILABILITY

A wheelchair in which a large wheel can move rearward can provide new convenience to those who use the existing wheelchair. In particular, the wheelchair can be very helpful for the elderly or patients who have difficulty moving alone to get in and off of a wheelchair. The wheelchair can provide essential functions to the existing wheelchair, not a special wheelchair with special functions. Accordingly, the wheelchair can become a new standard for wheelchairs, and thus, can be sold in the existing wheelchair market.

What is claimed is:

1. A mechanism for moving a wheelchair wheel rearward, comprising:
a guide rail attached to a wheel frame to move a wheelchair wheel shaft support;
a straight guide slider connected to the wheelchair wheel shaft support to easily move on the guide rail;
a pivot fixed to the wheelchair frame and becoming a rotation center of a pivot link moving the wheelchair wheel shaft support forward or rearward;
the pivot link slidable or changeable in length through a pivot guide slider for a straight line movement of the wheelchair wheel shaft support while rotating about the pivot fixed to the wheelchair frame; and
a wheelchair armrest connected to the pivot link to move the wheelchair wheel shaft support forward or rearward and serving as a lever rotating the pivot link about the pivot.

2. The mechanism for moving a wheelchair wheel rearward of claim 1, wherein the wheelchair frame supporting a load simultaneously serves as a guide rail.

3. The mechanism for moving a wheelchair wheel rearward of claim 1, further comprising a straight guide module, which adjusts an installation height of the wheelchair wheel shaft support which easily fits or removes a wheelchair wheel central shaft, and on which the straight guide slider and the pivot guide slider are mounted.

4. The mechanism for moving a wheelchair wheel rearward of claim 1, further comprising devices configured to fix the wheelchair armrest to the wheelchair frame so that the wheelchair wheel central shaft does not move forward or rearward of the wheelchair while the wheelchair travels.

5. The mechanism for moving a wheelchair wheel rearward of claim 1, further comprising a wheelchair side protector laid on a chair or a patient bed having a height different from that of the wheelchair, through a soft connecter of which one end is connected to the wheelchair side protector and the other end is connected to the wheelchair frame when wheels move rearward and then a user gets in or off of the wheelchair.
